(19) United States
(12) Patent Application Publication
(10) Pub. No.: US 2004/0236640 A1
(43) Pub. Date: Nov. 25, 2004

(54) System for producing on-line content from web sites on demand

(76) Inventor: Peter Kassan, Dobbs Ferry, NY (US)

Correspondence Address: OSTROLENK FABER GERB & SOFFEN, 1180 AVENUE OF THE AMERICAS, NEW YORK, NY, 100368403

(21) Appl. No.: 10/671,194

(22) Filed: Sep. 25, 2003

Related U.S. Application Data
(60) Provisional application No. 60/460,352, filed on Apr. 3, 2003.

(51) Int. Cl. G06F 17/60

(52) U.S. Cl. 705/27

(57) ABSTRACT

A visitor of a web site can receive at least some of the contents displayed in the web site in a printed form. More particularly, an on-line service provider operating an information processor provides software for proprietors of web sites who are desirous to provide a printed form of the content in their web sites. Once the web site that receives the software, a visitor can request at least a portion of the web site to be reproduced in printed form. The information received in the request is used to reproduce the content in printed form.

### CROSS-REFERENCE TO RELATED APPLICATIONS

The present invention is based on and claims priority to U.S. Provisional Patent Application Ser. No. 60/460,352, filed on Apr. 3, 2003 and entitled “SYSTEM FOR PRODUCING MAGAZINES FROM WEB SITES ON DEMAND,” the entire contents of which are incorporated by reference.

### FIELD OF THE INVENTION

The present invention relates generally to Internet web site content distribution, and, more particularly, to reproducing Internet web site content on printed media.

### BACKGROUND OF THE INVENTION

Many sites on the World Wide Web of the Internet (hereinafter, “web sites”) are magazine-like in format, or present a number of magazine-like sections. In many cases, the site, or specific magazine-like section often comprising columns and/or rows of simulated or virtual “pages” and including photographs or pieces of art, are meant to be viewed as a whole. With respect to photography, small “thumbnail” images are typically provided that, when selected via a click of a mouse or other pointing device, cause larger, more viewable images to be displayed. In other cases, web sites are not magazine-like at all, and consist entirely of text.

It is well-established that people prefer to read documents on physical paper rather than on a computer display (see, for example, The Myth of the Paperless Office, by Abigail J. Sellen and Richard H. R. Harper [MIT Press, 2001]). It is also well-established that people like to view, collect and own art, graphics, and photography on paper or similar medium, such as books and magazines. Printing web site “pages” that comprise art, graphics, and photography, for example, on a user's home printer, usually yields unsatisfactory results despite a similarity between “pages” on Internet web sites and physical pages in a book or magazine. Even text-based web sites that are printed on a home printer are, typically, unsatisfactory as people prefer printed text in, for example, a bound volume.

A typical cause for such unsatisfactory results is that web pages are usually not formatted to be reproduced on standard-sized printer pages. For example, printed web sites frequently run onto subsequent, partially filled pages. Other problems include partial or incomplete printing, and printing of undesired content, for example, programming code or coded representations of objects. Internet web sites rarely, if ever, resize oversized images for home printing, so that the images typically print on successive pages or are truncated. Although a skilled user can often find a way to format a printed web page properly (such as by printing only a selected “frame”, printing only selected material, or sizing an image to fit the paper), most users do not know how to do so, or find it too much trouble to do so, particularly for large numbers of pages.

Moreover, navigation links and other material that is often included at the bottom of each web page are typically repeated at the end of each section when it is physically printed. Also, many printing devices do not accommodate double-sided printing. Although some printing devices have double-sided capability, users often forget or don't know how to set their printing device to do so. Some printing devices, for example many kinds of laser printers, also do not print in color, although the majority of web sites use color. Further, optimal results for art, graphics, and photography web pages are only achieved by using special, expensive paper. Moreover, photo-quality paper is rarely distributed with a double-sided capacity.

Even if a user has the appropriate printing device, paper, and skills to format and print web pages such that they are well laid-out on both sides of a set of pages of appropriate quality, the print jobs are typically output on unbound single sheets of paper and are also, therefore, unsatisfactory.

Also, some web sites provide portions that are available in the PORTABLE DOCUMENT FORMAT (“PDF”), as developed by ADOBE SYSTEMS. The PDF versions can be printed on a user's home computer printer. However, these printed documents suffer from all of the limitations described above with respect to loose sheets of paper that are, typically, not designed for high-quality images. Moreover, PDF documents offered by various web sites usually provide content in conjunction with a web site, rather than providing content that is displayed in the web site. For example, technical manuals and journals, white papers and sales brochures comprise typical PDF documents that are available on Internet web sites. One skilled in the art will recognize that it is possible to produce a PDF document comprising content in a web site. However, printing such a PDF results in many if not all of the same problems identified above.

In summary, therefore, a “web page” that is printed, for example, by using native web browser functionality, is not a “formatted print page.” A collection or a series of typical web pages do not naturally or logically easily translate to a correct sequence of printed pages as they appear in a typical publication, such as in a book or a magazine. As used herein, “formatted print pages” refer, generally, to pages that comprise text, graphics and/or images that are printed on a particular paper size, in a particular format and layout, using specific colors or print technology with sequential print pages that can be placed on the same side of sequential printed pages or in a double-sided arrangement. Typically, the resolution of formatted print pages is 70 times higher than that displayed in typical web pages. As used herein, the term “formatted print pages” refers, generally, to printed content, at least some of which is identified in an Internet web site and is printed including characteristics, as described herein. Formatted print pages have a much more attractive, professional form and appearance over prior art forms, substantially as described above. Furthermore, a typical web page can be designed in practically unlimited width and length. Typical web browser software provides horizontal and vertical scroll bars automatically while displaying a web site that extend horizontally and/or vertically beyond the viewable region of a display screen. These, and other known variables affecting the layout of a web page, contribute to fundamental differences between a web page and a formatted print page.

Also as used herein, formatted print pages refer to printed pages that meet at least some criteria set forth above, such that the web site content can be utilized by a printing company or other production entity to create print media, including web site content that is combinable or that can be bound into a book, a magazine or the like.

A drawback of the prior art ensues from the fact that users cannot obtain printed web pages that are bound in a book-like or magazine-like fashion. Web sites may purport to provide a user with a printable version of web pages (so-called “printer friendly” versions), but do so without any specific knowledge of the printing equipment on which such pages are to be printed, resulting in all of the foregoing drawbacks of the prior art. In other words, a web host provides web pages without any ability and without including any special software that assures that the user will obtain a pre-defined page layout and sequencing that will be standardized to the particular web pages being displayed.

Many kinds of systems exist for binding sheets of paper, such as hard or soft-cover loose-leaf binders and plastic binding strips that are slid along the left margin of a set of pages, staples and the like. However, these systems are never as satisfactory as saddle-stitched or perfect bound books or magazines for several reasons. For example, the holes necessary to place pages into loose-leaf binders may overlay text or an image of the page. Also, loose-leaf binders are often bulky and do not file well on bookshelves since they are usually not rectangular, but triangular solids. Furthermore, binding strips often obscure parts of the text or image area of the pages and make the resulting collection of papers impossible to lay flat on a horizontal surface, such as a desk.

Stapling materials also results in similar defects as described above with respect to binding strips. Stapling usually works well only with a relatively small number of pages, unless a heavy-duty stapler (not usually an item of home use) is used. Stapling also often damages pages, which are then prone to tearing.

Referring to the drawings in which like reference designators refer to like elements, FIG. 1 shows a prior art hardware arrangement for viewing, reviewing and outputting internet web site content. As shown in FIG. 1, an information processor with web server 2 provides electronic content to a user terminal 4 that communicates with the information processor 2 via communication network 16. The user terminal preferably employs software that enables a communication session to be established between the user terminal 4 and the information processor with web server 2. Preferably, the information processor 2 employs software enabling a communication session, for example an HTTP session, to be established between the user terminal 4 and the web server 2. Information processor 2 typically provides content over the Internet which can be received by user terminal 4. Content includes, for example, text, graphics, pictorial, audio and video material.

Also as shown in FIG. 1, an output printer 7 is preferably controlled by user terminal 4 to provide printed output of content. For example, after a person views content on user terminal 4 using typical web browser software, the person selects an option to print the content on printer 7. The printed version, unfortunately, is typically unsatisfactory for the reasons set forth above.

There is a need in the industry to provide printed versions of web site content, as a whole or in part, as formatted print pages.

### SUMMARY OF THE INVENTION

The present invention solves many of the above-described problems by enabling web sites operators who wish to offer magazine-like printed versions of all or some of their web site contents to do so in a way that is economical for both them and their viewers.

The present invention is directed to a method for providing printed pages of web hosted information in response to an electronic request received over a communication network. The method includes providing add-in software that operates within a web site and enables a visitor of the web site to submit a request for receiving a printed copy of web hosted information that is displayable as web pages. The method further includes receiving electronic order information representing the request and processing the electronic order information to provide electronic production information representing instructions for fulfilling the request. The method further includes transmitting the electronic production information to a fulfillment facility and providing to the visitor the requested web hosted information from the fulfillment facility in the form of printed pages.

The present invention is further directed to a system for providing formatted print pages that comprise content represented in a web site. The system comprises add-in software operable with the web site that enables a visitor of the web site to submit an electronic request for the formatted print pages. The system includes a request receiving module that receives the electronic request over a communication network, and a request processing module that processes the contents of the electronic request and provides electronic production information that provides instructions for fulfilling the electronic request. The system also includes a transmitting module that transmits the electronic production information to a fulfillment facility operable to provide the formatted print pages corresponding with the electronic production information, and a formatted print pages delivery module operable to provide to the visitor the formatted print pages.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a prior art hardware arrangement for viewing, reviewing and outputting internet web site content;

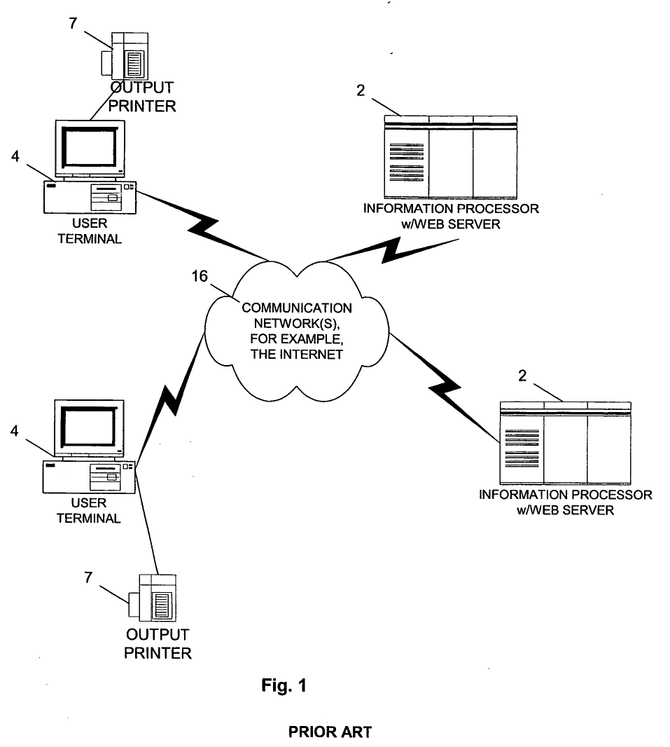

FIG. 2 shows an example hardware arrangement of a preferred embodiment of the present invention;

FIG. 3 is a block diagram illustrating the functional elements in an example information processor;

FIG. 4 is a block diagram that demonstrates interactions between parties and modules associated with the present invention;

FIG. 5 is a flow chart that identifies functionality including the interaction between the devices in accordance with the present invention;

FIG. 6 is a flow chart that identifies steps associated with receiving a single transaction in accordance with the present invention; and

FIG. 7 is a flow chart that identifies steps associated with fulfilling a request for formatted print pages in accordance with the present invention.

### DETAILED DESCRIPTION OF PREFERRED EMBODIMENTS OF THE INVENTION

The present invention enables a visitor of a web site to receive at least some content displayed in the web site as formatted print page(s). As used herein, the terms “visitor” and/or “visitor terminal” refer, generally, to a person and/or device operated by a person that establishes a communication session over a network with another device. More particularly, an on-line service provider, operating an information processor and referred to herein, generally, as a “production information processor,” preferably provides software for proprietors of web sites who are desirous to provide formatted print pages of content displayed in their web sites, or content related thereto.

Once a web site, referred to herein as a “customer web site,” receives the above-identified software and incorporates the software appropriately into the customer web site, a visitor to the customer web site can request at least a portion of the web site to be reproduced as one or more formatted print page(s). The term, “customer” is used because, preferably, proprietors of web sites using the software provided by the production information processor are customers of the proprietors thereof. The production information processor preferably uses information received in a request to provide formatted print pages. The production information processor contributes to the production of the formatted print pages in accordance with predetermined styles and layouts.

The software provided by the production information processor (hereinafter, the “add-in software”) is used in connection with one or more software programs that generate a customer web site. The add-in software preferably allows visitors to the customer web site to order formatted print pages comprising the content provided in or related to the customer web site. The add-in software functions to transmit information about an order for formatted print pages to one or more production information processor 12.

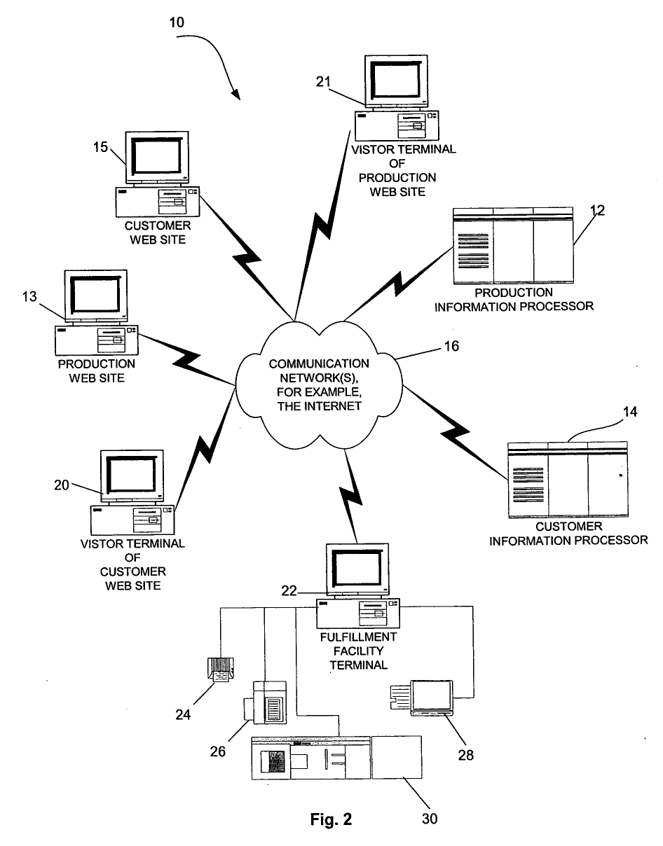

FIG. 2 shows an example of a preferred embodiment of the present invention, including a hardware arrangement for providing formatted print pages comprising web site content, and referred to generally as system 10. System 10 comprises at least one production information processor 12 and at least one customer information processor 14, each of which are adapted to access communication network 16. The production information processor 12 and the customer information processor 14 each preferably provide respective Internet web sites (13 and 15, respectively) that includes content for respective visitors.

Also as shown in FIG. 2, a fulfillment facility terminal 22 communicates with at least the production information processor 12 and receives instructions with respect to a request for formatted print pages. Although the embodiment shown in FIG. 2 identifies the fulfillment facility terminal 22 separate from the production information processor 12, the fulfillment facility terminal 22 can be under the direct control of the proprietor of the production information processor 12.

In the example shown in FIG. 2, fulfillment facility terminal 22 preferably includes a formatted print page output printer 24. In addition to the formatted print page output printer 24, one or more other devices are preferably provided and used in accordance with the present invention. For example, a fulfillment facility terminal 22 employs a binding machine 28 to combine individual sheets. Further, a saddle stitch machine 30 may be included to provide a professional appearance for the printed output. Further, a folding machine 26 may be employed by the fulfillment facility terminal 22 in order to prepare signatures, i.e., sets of one or more sheets for binding. As shown in FIG. 2, the output related devices, including, the folding machine 26, binding machine 28, and saddle stitch machine 30 are presented as separate and apart from the formatted print page output printer 24. Of course, one skilled in the art will recognize that two or more of these devices may be integrated into a single device. For example, the formatted print page output printer 24 may have a series of attachments that comprise a folding machine and a binding machine. The folding machine and binding machine can operate to produce one or more signatures.

Production information processor 12 preferably includes all databases necessary to support the present invention. However, it is contemplated that production information processor 12 can access any required database via communication network 16 or any other communication network to which production information processor 12 may be coupled. Communication network 16 is preferably a global public communication network such as the Internet, but can also be a wide area network (WAN), local area network (LAN), or other network that enables two or more computers to communicate with each other.

In the preferred embodiment, production information processor 12 and customer information processor 14 are any devices that are capable of sending and receiving data across communication network 16, e.g., mainframe computers, mini computers, personal computers, laptop computers, a personal digital assistants (PDA) and Internet access devices such as Web TV. In addition, production information processors 12 and customer information processors 14 are preferably equipped with a web browser, such as MICROSOFT INTERNET EXPLORER, NETSCAPE NAVIGATOR and the like. Production information processors 12 and customer information processors 14 are coupled to communication network 16 using any known data communication networking technology.

Alternatively, the add-in software includes features that enable a visitor terminal 20 to compose and edit electronic representations (i.e., previews) of formatted print pages. For example, a visitor terminal 20 can select from predefined styles and layouts, and thereafter modify the electronic representation, for example, by resizing images, modifying column widths, and changing text fonts and point sizes. After the visitor terminal 20 finishes modifying the electronic representation, the representation is transmitted to the production information processor 12 and/or the fulfillment facility terminal 22 for production of formatted print pages.

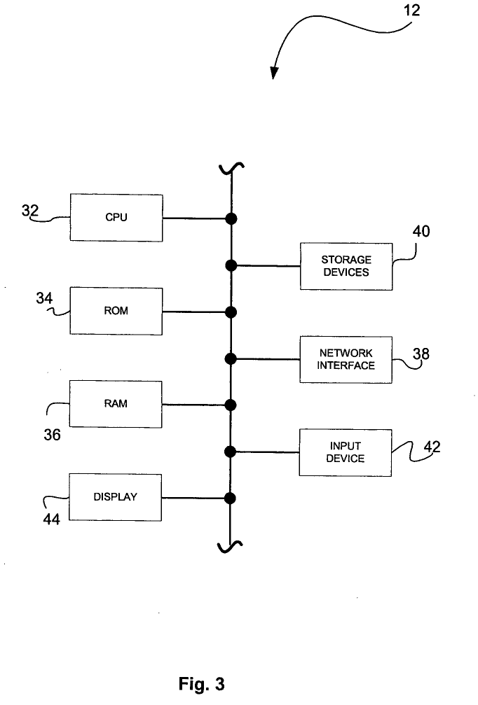

As shown in FIG. 3, the functional elements of each production information processor 12 are shown, and include one or more central processing units (CPU) 32 used to execute software code and control the operation of production information processor 12, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of production information processor 12 need not be physically contained within the same chassis or even located in a single location. For example, storage device 40 may be located at a site which is remote from the remaining elements of production information processor 12, and may even be connected to CPU 32 across communication network 16 via network interface 38. Production information processor 12 preferably includes a memory equipped with sufficient storage to provide the necessary databases, forums, and other community services as well as acting as a web server for communicating hypertext markup language (HTML), Java applets, Active-X control programs or the like to customer information processors 14. Production information processors 12 are arranged with components, for example, those shown in FIG. 3, suitable for the expected operating environment of production information processor 12. The CPU(S) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of production information processor 12 shown in FIG. 3 are of the same categories of functional elements present in customer information processors 14. However, not all elements need be present in the customer information processor 14. For example, storage devices, in the case of PDA's, and the capacities of the various elements are arranged to accommodate the expected user demand. For example, CPU 32 in customer information processor 14 may be a smaller capacity CPU than the CPU present in the production information processor 12. Similarly, it is likely that the production information processor 12 will include storage devices of a much higher capacity than storage devices present in customer information processor 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., production information processor 12), system 10 is not limited to such a configuration. It is contemplated that system 10 is arranged such that customer information processor 14 communicates with and displays data received from production information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on production information processor 12 and customer information processor 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on production information processor 12 and customer information processor 14 regard the process of communicating data across communication network 16 and processing the data such that the data is viewed on a display 44, for example by using a web browser and the like. As is common with web browsing software, the display 44 on customer information processor 14 presents sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

As used herein, the term “proprietor” refers, generally, to an owner/operator of a device, such as an information processor 12 or user terminal 14. A proprietor does not have to be in physical proximity with the device in order to exercise control over it. Also as used herein, a proprietor refers to a party who exercises control over the content and features provided on a web site and/or information processor.

As noted above, production information processor 12 preferably provides a production web site 13 to which visitors can connect. Production web site 13 is available to anyone who is able to establish a communication session with the production information processor 12. Once the session is established, the visitor can view content regarding services provided by the production information processor 12. Such content is considered herein, generally, as “public” content because access thereto is unrestricted. Production web site 13 preferably also includes content which is restricted to authorized personnel, for example, registered customers who have contracted for the services provided by the proprietor of the production web site 13. Such content is referred to herein, generally, as “private” content.

Customer information processor 14 preferably comprises customer web site 15 that includes content for visitors of customer information processor 14. As noted above, with respect to the production web site 13, the customer web site 15 also preferably includes public content that is available to terminals capable of establishing a communication session with the customer information processor 14.

Any user terminal that establishes a communication session with the production web site 13 can preferably view the public content provided therein. For example, a proprietor of a web site that provides Internet content regarding emerging software technologies desires to offer its visitor terminals 20 the content in formatted print pages. Accordingly, the proprietor (or authorized agent thereof) browses the production web site 13 and determines that functionality provided in accordance with the present invention is desired. Accordingly, the proprietor of the web site contacts the proprietor of the production information processor 12 in order to request tools for providing formatted print pages in accordance with the present invention. The proprietor of the web site preferably registers with the proprietor of the production web site 13 to become a customer and proprietor of a customer web site 15 in order to receive software and/or hardware tools used for providing the functionality described herein.

In one embodiment, after a person operating visitor terminal 20 views content provided in the customer web site 15, the person registers with the customer information processor 14 in order to receive formatted print pages of the content. During the registration process, for example, the person operating visitor terminal 20 preferably provides information requested by the customer information processor 14, such as name, electronic mail address, and other desired information. Preferably, once the visitor terminal 20 is provided authorization by the customer information processor 14 (i.e., the visitor terminal 20 is registered) then the visitor terminal 20 can submit a request for formatted print pages comprising the same or related content.

Preferably, the proprietor of customer web site 15 and wishing to provide formatted print pages to its viewers installs the tools provided by the production information processor 12 to the customer web site 15. The tools, preferably bundled in add-in software to the customer web site 15, allow viewers to electronically order formatted print pages of one or more selected portions of the web site, or related content not necessarily provided on the customer web site 15.

The customer web site 15 may make use of its own order-taking facilities, or may make use of order-taking facilities provided by the add-in software. The customer web site 15 software, with or without the add-in software, may include e-commerce provisions, such as for taking credit card or debit card information, issuing a bill, or other processing for receiving payment for selected items.

An order for formatted print pages is preferably transmitted electronically, via the Internet or other network, to production information processor 12. The proprietor of customer information processor 14 preferably makes available to the production information processor 12 the appropriate content of customer web site 15 by a variety of methods, including a link to access the content, for example, by file transfer protocol (“FTP”) or e-mail. Preferably, the content provided by the proprietor of customer web site 15 to the production information processor 12 has a much higher resolution than that displayed on the customer's web site 15. Graphic content that is displayed on customer web site 15 is formatted in order to accommodate varying speeds of the network connections for the plurality of parties. Therefore, the resolution of the content is lower than that included in formatted print pages. Content distributed to a fulfillment facility terminal 22 and eventually used for formatted print pages is typically of a much higher resolution, in part because the connection speed is not an issue.

Moreover, the proprietor of customer web site 15 can provide content as links thereto that is related, but not necessarily displayed on the customer's web site 15. For example, a customer web site 15 providing images of various species of birds may receive orders for a plurality of images of a single species of birds that are not available on the web site 15. Alternatively, a proprietor of customer information processor 14 transmits to production information processor 12 content not displayed in web site 15 for formatted print pages. Continuing with the previous example, related images of the species of bird are provided by the proprietor of the customer information processor 14 to the production information processor 12. Preferably, such content is provided that is more suitable for printing, for example, with copyright masks and other markings removed therefrom.

In one embodiment, the proprietor of the production information processor 12 receives content from each customer information processor 14 for formatted print pages, in accordance with the present invention.

The production information processor 12 preferably receives requests for formatted print pages of web site content. Preferably the content is imported into layout manipulation software (such as INDESIGN) and is arranged on individual pages (including the front and back cover, and the spine, if any). The proprietor of the production information processor 12 may select images to fit a magazine format of a predetermined number of pages, and may resize certain images to increase (or decrease) the number of images that may fit on a single page.

The proprietor may also add pages of additional information, or may add information to existing pages, such as advertising, information about the company operating the production facility terminal 22, and appropriate copyright information.

The proprietor of the production information processor 12 may also add front matter, such as a title page, table of contents, forward and the like, and back matter, such as one or more indexes. The proprietor may also apply a style, for example, repetitive elements such as titles, dates, and page numbers. The style may be manipulated and adjusted, for example, by changing the typeface, point size, arrangement, and the like. The software used by the proprietor of the information processor 12 may also provide for adding all or some information automatically, as directed by control information included in a request for formatted print pages, stored in the computer at the production facility, or both. The proprietor may also add information or pages to the inside or outside front or back cover to be printed. Further, the mailing or shipping information may also be included on the front or back outside cover.

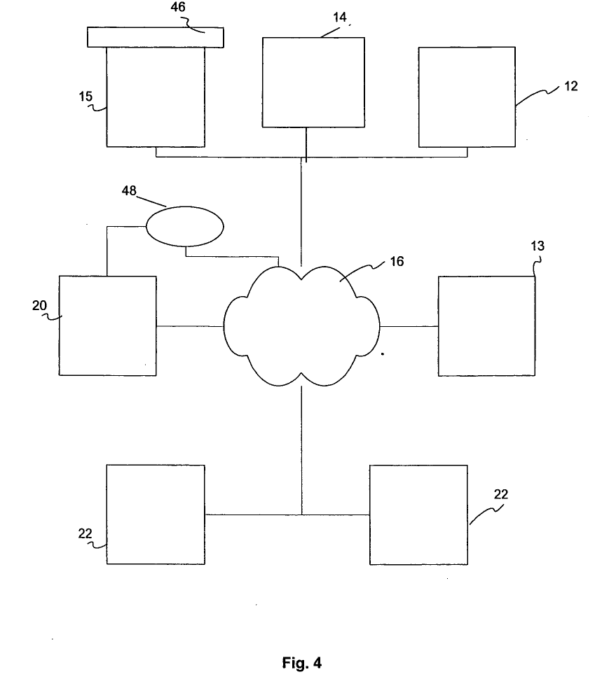

FIG. 4 shows a block diagram that illustrates the relationship associated with the parties and modules to the present invention. Preferably, the production information processor 12 provides add-in software 46 to the customer web site 15 in order to contribute to the processes described herein. The add-in software 46 is preferably distributed from the production information processor 12 in order to enable a customer web site 15 to provide formatted print pages in accordance with the present invention. For example, the add-in software 46 comprises commands and controls that are embedded and/or displayed in a customer web site 15, and provide for manipulating content to comply with formatting specifications, such as page layout specifications and binding preferences. Other functions provided by add-in software 46 include an interface for a visitor terminal 20 to submit information about the visitor. For example, the add-in software 46 provides a data entry form that is preferably used by the visitor terminal 20 to provide information, for example, order, payment and shipping information. Further, the add-in software 46 provides an interface for the visitor terminal 20 to identify the specific content related to the customer web site 15 that the visitor terminal 20 wants to be provided in formatted print pages. Information regarding an order (e.g., selected content, layout information, copyright and ownership information, payment and shipping information) is referred to herein as control information, and is used by the production information processor 12 and/or fulfilment facility 22 to provide formatted print pages of web site content, substantially as described herein.

As shown in FIG. 4, a visitor terminal 20 communicates with the customer information processor 14 in order to view content provided thereon. The visitor terminal 20 identifies content that the visitor terminal 20 wants to receive in formatted print pages. A request 48 for the formatted print pages, including a representation of the content, for example, a file name or other identifier, is preferably transmitted to the production information processor 12. The production information processor 12 uses the representation of the content to transmit the content along with control information to a fulfillment center terminal 22. The fulfillment center terminal 22 preferably processes and outputs formatted print pages comprising content, in accordance with the visitor's 20 preferences.

In a preferred embodiment, a request for formatted print pages is transmitted by a visitor terminal 20, and received by the production information processor 12. Once received, the production information processor 12 preferably performs operations on the transmitted request, for example, to confirm that the information contained therein is correct. After the production information processor 12 concludes that the information in the request 48 is accurate, then the information in the request 48 is preferably forwarded to a fulfillment center terminal 22. The fulfillment center terminal 22 preferably uses the one or more hardware devices, described above and shown in FIG. 2, in order to provide the formatted print pages to the requesting visitor terminal 20.

Preferably, software is used at the production web site 15 that provides for communication between the production information processor 12, and the operators of its customer web sites 15. As noted above, public content of the production web site 13 is accessible to anyone, while access to private content is restricted to those having sufficient authorization, for example, a user name and password.

Preferably, the present invention also provides previous versions and/or editions of formatted print pages. For example, a visitor 20 can submit a request for formatted print pages previously provided in accordance with the present invention. Editions may differ according to paper quality, the paper quality of the cover (if different from the rest of the formatted print pages), the means of binding, and other distinguishing factors. Each edition is preferably associated with appropriate control and identifying information so that different editions can be conveniently ordered and regenerated. All such information may be made available for viewing on the production web site 13 and can be transmitted back to the customer web site 15 for its own use for transmitting future orders.

Control information, preferably transmitted in a request 48 for formatted print pages, can comprise several kinds of information. For example, control information includes an identification of the customer web site 15 that is originating the order, the portion or portions of the customer web site 15 is being ordered, and information regarding the visitor terminal 20 placing the order. Optionally, control information also includes the version or edition of the formatted print pages. Preferably, the name, mailing or shipping address, and mailing or shipping specifications and the email or other electronic address of the person placing the order is included in the control information. Other information may be provided, as necessary and appropriate, including information about the fulfillment facility terminal 20 providing printing services for all or selected formatted print pages printed by the entity and the like.

Preferably, an email or other electronic acknowledgment indicating receipt of an order for formatted print pages is transmitted from the production information processor 12 to a contact designated by the owner, proprietor, or operator of the customer web site 15. Furthermore, an email or other electronic acknowledgment is transmitted to the person placing the order, for example, upon a receipt and when the formatted print pages are prepared.

Moreover, software is preferably provided that calculates a suggested retail price or other price to the proprietor of customer web site 15 and/or visitor 20 for various editions of the formatted print pages. In accordance with the present invention, a calculated price is preferably provided to the proprietor of customer web site 15, for approval and optional incorporation into the customer web site 15.

Software is further preferably provided that substantially automatically (i.e., with or without operator intervention) resizes images to fit an intended page size, with or without provision for margins, as appropriate or desired. Software is also preferably provided that displays a set of thumbnail images in reduced size so that an operator or user can conveniently make a selection of images to be included in formatted print pages. The present invention provides for convenient selection of images based on classification and search criteria. For example, a graphic user interface is provided for identifying portions of a customer web site 15 for formatted print pages.

Optionally, software is provided to accept metatag, filename, and operator-input text, as well as other information regarding the content, the respective photographer(s) or artist(s), model(s) and date(s). Other information is preferably used to permit classification, searching, and selection based on criteria such as photographer, artist, model, subject matter, theme, and the like. Software is further preferably provided to edit, add, delete, and otherwise manipulate such information.

Software is optionally provided, for example, on the production information processor 12 that provides the ability to easily place several images that are automatically resized (as necessary) into a grid or arrangement on a single page. In this way, if the number of images to be printed will exceed the maximum number for a predetermined page size, the images can be resized and, therefore, fit on the page.

Software may also be provided that allows a proprietor of production information processor 12 to create and/or identify front matter (such as a title page or a Table of Contents) and back matter (such as indexes of various kinds). Optionally, software is provided that allows the proprietor of production information processor 12 to apply at least one of a set of styles to the formatted print pages, including repetitive components, such as titles, dates, page numbers, etc.

Further, the present invention preferably allows a proprietor of production information processor 12 to choose and manipulate a style chosen for particular formatted print pages. Additionally, software is provided that allows the operator of a production information processor 12 to add a newly created or modified style to a set of styles that are available for production of formatted print pages.

Moreover, the proprietor of the production information processor 12 preferably stores specifications for formatted print pages that are automatically reapplied for future issues of the same or similar formatted print pages.

Optionally, software is provided that electronically simulates a layout of the formatted print pages. The simulation is provided on the production web site 13 and/or the customer web site 15 for viewing, review, and approval. Alternatively, the system 10 includes software that allows the production information processor 12 to send simulated formatted print pages to a designated contact at the customer web site 15. Such software can be email that supports electronic attachments, such as MICROSOFT OUTLOOK.

Preferably, software allows the visitor terminal 20 and/or proprietor of the customer web site 15 to indicate approval of, or to request changes to, a proposed layout of formatted print pages. Such software is preferably incorporated into the production web site 13 or, alternatively, may be email-based.

Software is also preferably provided that allows a visitor terminal 20 or proprietor of customer web site 15 to layout individual pages in a preferred order so that when a series of multi-page sheets of paper are printed, the pages are arranged properly. After printing and binding, the pages are in the correct serial order (known in the art as “imposition”).

One or more computer-linked printing machines are preferably provided that use laser, inkjet, bubble jet, dye emulsion or similar relatively low-cost, low-volume technology (referred to, generally herein as “computer printers”). Computer printers are preferably capable of printing pages roughly twice the size of the desired finished product (that is, for example 11×17″ to produce 8½″×11″ or A3 to produce A4).

Optionally, one or more print devices are included that are adapted to print an edge of a finished page, so that “full-bleed” printing can be achieved without trimming. Further, one or more printing devices are provided that are not adapted to print to the edge of a finished page, yet can print pages more than one or two times the finished size, so that “full-bleed” printing can be achieved by trimming the printed page to the desired size. Also, one or more computer printers supplied with pages of different paper quality, size, and thickness are provided that print different editions and/or different sections of the formatted print pages, such as a front cover. One or more computer printers capable of printing in only a single color of ink, such as black, can also be included. Moreover, one or more computer-linked printing machines capable of printing from rolls of paper to produce covers of variable length for perfect-bound formatted print pages is preferably provided.

Furthermore, one or more machines is preferably provided to fold a set of pages vertically in the center for perfect binding or “saddle stitching” (i.e., stapled or sewn along the center fold). Moreover, one or more machines for perfect binding, including machines for preparing the edges of a set of pages for gluing, is preferably provided.

Presses that achieve a full-bleed effect by printing on oversized paper and then trimming are much more common than presses that actually print to the edge of a paper. Accordingly, one or more machines is provided for cutting off the edges of one or more pages to create full-bleed printing, as well as to square up the edges of pages after folding. Some of these machines are commonly known in the art as “trimmers” or “trimming machines.”

The machines can be adapted to be used with a variety of binding systems meant to be used for low-volume, manual or semi-manual binding, such as spiral binding systems, hot glue binding systems, etc. In some of these systems, the pages are printed double-sided, but on single- rather than double-size sheets of paper, and are not folded before binding.

Software is preferably provided that lays out content and drives printing devices to print formatted print pages, including, for example, to print the spine, the inside and outside front and back covers of perfect-bound formatted print pages on a variable length sheet of paper. Software is also preferably provided to print an individual mailing or shipping label using information from the order transmitted (with or without preprinted postage, such as software provided by the USPS, or independent software companies).

Furthermore, software is preferably provided for printing different portions of formatted print pages (such as the cover, particular pages, and the mailing label) by different printing devices. Such software can comprise facilities common to the operating system of the computer on which the software is being run, such as MICROSOFT WINDOWS.

Other functionality provided by the present invention includes recording, managing, and reporting orders, either individually or in the aggregate, for financial and management purposes.

Information that will not change from order to order, such as a layout of formatted print pages and their imposition for correct printing, is preferably saved in electronic form. Layout information and corresponding control information is stored so that the printed formatted print pages of the same or similar content can be conveniently regenerated the next time content is ordered, as well as when future issues of the formatted print pages are ordered.

An operator of the present invention who contributes to the production of formatted print pages preferably manipulates the finished pages in imposition software, such as PREPS, to arrange the pages in a correct order, for example, for double-sided, double-paged printing substantially automatically. The operator then provides instructions for the finished product for output. As noted above, a variety of printing devices may be provided.

At any convenient time during the process, the operator of the present invention produces and/or prints a mailing or shipping label, for example, if mailing or shipping information is not printed directly on the formatted print pages (i.e., first or last page or cover of the finished product). For example, the operator takes the printed sheets and, using the folding machine, produces one or more signatures of folded page. If the formatted print pages are being saddle stitched, the operator preferably uses the appropriate machine to saddle stitch the signature. If the formatted print pages are to be perfect bound, the operator may finish production by using a perfect binding machine. As noted above, in some perfect binding systems, the pages are printed double-sided, but on single- rather than double-size sheets of paper, and also are not folded before binding. The mailing label can then be easily applied on or near the formatted print pages.

Frequently, the formatted print pages are packaged with other items, for example, separate advertising material. The mailing label, if separately produced, may be added to the outside cover of the formatted print pages at this time, or may be added to an envelope into which the formatted print pages are placed. Other manipulating steps, such as closing the individual sheets with an adhesive tab, are known to those familiar the printing industries. In accordance with the present invention, the operator may omit or add certain steps, depending upon the context of the order. For example, subsequent orders for formatted print pages comprising the same or related content of a previous order may require the operator to retrieve a stored layout and style. Alternatively, the receipt of an order for a previously ordered similar or same formatted print pages is automatically recognized and that version is substantially automatically retrieved.

Although the foregoing steps are described in a particular and sequential order, several of the steps could be combined and performed by a single automated machine, such as folding, saddle-stitching, and perfect binding and in another order. Other improvements and variations are known to those familiar with printing industries.

In a preferred embodiment of the present invention, a production web site 13 provides access to the features and functionality described herein. Below is a description of features preferably provided by the production web site 13.

Unrestricted access to public content is preferably provided by the production web site 13. This includes one or more sections that explain the business for prospective customers. Sections are also preferably provided for prospective purchasers of formatted print pages, and preferably provide examples of content, layouts and styles that are available. The sections are optionally organized by category of content and preferably incorporate links to respective customer web sites 15.

Furthermore, a mechanism for browsing content, or designated portions of content, according to the preferences of each customer is also preferably provided. Also, a mechanism for ordering one or more copies of formatted print pages comprising selected content is provided. A mechanism is also preferably provided for subscribing for regular receipt of formatted print pages. Another mechanism is preferably provided for purchasers or subscribers to provide payment information, such as debit credit card information, electronic payment information, and other payment mechanisms as are standard and customary.

As noted above, production web site 13 also preferably provides private content that is available only to authorized visitors, for example, those who supply an appropriate user ID and password in order to gain access. Restricted content provided on production web site 13 preferably includes the following features:

display of sample formatted print pages, including example editions, formats and layouts for selection, along with pricing information (including both actual pricing and suggested retail pricing);

a mechanism for the proprietor of customer web site 15 to indicate which editions, formats, and layouts the proprietor of customer web site 15 wishes to make available to the public;

display of proposed layouts of a particular issue for approval by the proprietor of the customer web site 15;

a mechanism for the proprietor of the customer web site 15 to indicate approval or to communicate requested changes to a proposed layout of formatted print pages;

a mechanism for the proprietor of customer web site 15 to make changes to the proposed layout; and

a mechanism for the proprietor of customer web site 15 to input, edit, or modify copyright, address, and other information to be included in the formatted print pages.

Preferably, production web site 13 also includes a mechanism for the proprietor of customer web site 15 to indicate the portions of formatted print pages to be displayed as a sample for prospective proprietors of other customer web sites 15, either by selecting or excluding portions explicitly, indicating a number or proportion of pages, or the like.

Additional features of the production web site 13 providing private content include:

a mechanism for downloading and installing the add-in software to the customer web site 15;

display of financial, control, and management information, such as providing the number of visitor 20 orders by issue and edition; and

a mechanism for the proprietor customer web site 15 to remove availability of past issues or editions or to designate time-based rules for doing so.

When a visitor terminal 20 of the customer web site 15 identifies content that is the same or similar to that provided on the web site 15, the visitor terminal 20, via the add-in software, orders formatted print pages. The present invention preferably provides one or more mechanisms for the visitor terminal 20 to place an order. The mechanism(s) preferably comprise the following:

a display for the visitor 20 to enter all information needed to process the order, including a mechanism enabling visitors 20 to provide payment information, such as debit credit card information, electronic payment information and other payment mechanisms as standard and customary;

a mechanism for the visitor 20 to subscribe to receive formatted print pages regularly (e.g., a subscription);

a mechanism for the visitor 20 to preview other available formatted print pages, optionally restricted to those in a similar category of interest;

links to the customer web site 15 from which content in formatted print pages originates; and

a mechanism for tracking the customer web site 15 from which a visitor 20 navigated to the production web site 15, in part for purposes of compensating the customer web site 15 for purchase of formatted print pages from other customer web sites 15.

The software operating at the production web site 13 preferably performs the above-described actions substantially automatically, i.e., with or without the need for user control or intervention. However, an operator can preferably override, adjust, or cancel the automatic processing of software, for all or some selected images, sections, or pages. Also, software operating on the production web site 13 preferably includes the capability to provide tracking information for the demand for particular content, editions, and issues, and also to predict future demand. This information is preferably used to prioritize work to be performed by the operator before an order is actually received. For example, an operator can produce finished copies of formatted print pages, including everything up to addressee information, in advance of any order.

The display screen in which a purchaser or subscriber enters information for placing an order may be displayed via the production web site 13 or the customer web site 15. If displayed via the production web site 13, the display screen can appear as part of the customer web site 15.

As noted above, since high resolution versions of images are to be included for formatted print pages, system 10 preferably provides facilities for downloading high resolution images from the customer information processor 14 to the production information processor 12. The high resolution images substitute the lower resolution versions that are actually displayed on the customer web site 15.

The images and other material, whether higher resolution or not, can be obtained with the cooperation of the proprietor of the customer web site 15 for the purposes of creating the formatted print pages. This cooperation can be in the form of providing access to the customer web site 15 for purposes of downloading the images, providing access to locations where the images are stored, and the like. Once this cooperation is provided, the capturing of the images and other material can be substantially automatic, for example, on a continuing basis, or can be performed manually by an operator.

A visitor terminal 20 of customer web site 15 can subscribe to access restricted portions of the web site. Thereafter, software operating at the production web site 13 preferably reminds the operator thereof to produce the appropriate products for the appropriate subscriber. A visitor terminal 20 can also subscribe to changes to a web site or selected portions thereof. Software at the customer web site 15 or at the production web site 13 can monitor changes to the customer web site 15 automatically and provide formatted print pages comprising content directed to the changed content. Moreover, a visitor terminal 20 is able, via customer web site 15 or production web site 13, to order formatted print pages of related content that is provided on other customer web sites 15, or third-party web sites.

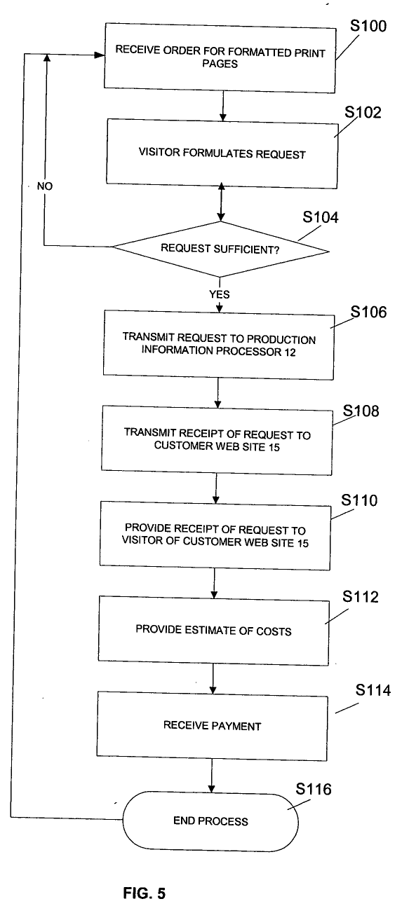

The above-described hardware and software provide a system which advantageously allows users to receive formatted print pages provided over the Internet. The specific functionality provided by system 10, and in particular with production information processor 12 and customer information processor 14, is illustrated in the following example including the interaction between the devices with reference to the flow chart shown in FIG. 5.

FIG. 5 demonstrates a flow chart illustrating the steps that occur at the client web site 15 when a visitor terminal 20 requests content in printed form. The example flow charts shown in FIGS. 5-7 represent a preferred sequence of events, it being understood that steps may be added, removed or changed without departing from the spirit of the present invention.

In step S100, a visitor terminal 20 identifies content in or related to the client web site 15 that the visitor wants. In step S102, the visitor formulates a request for formatted print pages via the add-in software 46. In step S104, a determination is made whether all information required for the request to be processed is collected. Information that can be processed in a request represents, for example, the originating customer web site 15, the content in or related to the customer web site 15, the particular edition, if any, that the visitor terminal 20 wants, and name, mailing address, billing information, professional information and any other information representing visitor terminal 20.

If the determination made in step S104 reveals that the request lacks certain information, then the process loops back to step S102 and the visitor terminal 20 modifies the request. When the request is sufficient for processing, the process continues to step S106, and the details of the request are transmitted to the production information processor 12. Preferably, in step S108, the production information processor 12 transmits a confirmation to the customer web site 15 that the request 48 has been received. The confirmation is preferably also provided to the visitor terminal 20 (step S110). In step S112, an estimate is preferably provided for the costs associated with fulfilling the order in the request 48. The estimate is preferably transmitted to the customer information processor 14, and is optionally used to generate a total cost of fulfilling a plurality of requests 48.

In a preferred embodiment, the production information processor 12 provides a cost for a particular edition of a formatted print pages which is paid by the proprietor of the customer information processor 14. The customer information processor charges the visitor terminal 20 that cost plus an additional fee. In this way, customer information processor can profit using the present invention, as can the production information processor. Preferably, the final amount due from the visitor terminal 20 for formatted print pages includes the cost charged by the production information processor, plus shipping and handling costs, plus an additional fee set by the customer information processor. Of course, one skilled in the art will recognize that variations on this theme are possible. For example, the production information processor 12 can set the final cost of delivering formatted print pages to the visitor terminal 20, including costs associated with production of formatted print pages, shipping and handling, and any other fees deemed appropriate by the production information processor 12, and the customer information processor 14 receives a flat rate (or, alternatively, a relative commission) for each order for formatted print pages. Other payment and/or e-commerce schemes can be adopted easily in accordance with the present invention.

Further, although the practice described above for step S112 comprises charging a visitor 20 for production and delivery of formatted print pages, occasionally the customer web site 15 will charge little or nothing for formatted print pages. Materials such as white papers, technical manuals, annual reports, marketing literature, advertising materials and other content that, typically, have few formatting processes performed thereon. A customer web site 15 may elect to provide formatted print pages comprising such content for free, or in unlimited quantity for a subscription fee, as a service to its visitor terminals 20. Preferably, the rates charged by production information processor 12 to the customer information processor are unaffected by the decision of a proprietor of a customer web site 15 to provide formatted print pages for free.

In order to facilitate e-commerce functionality, the present invention provides the total cost for fulfilling request 48, and also accepts payment from visitor terminal 20 therefor. The visitor terminal 20 preferably provides payment for the production of the printed output, for example, by submitting a credit card number or other form of payment. After payment is received, an identifier such as a confirmation number is preferably provided to the visitor terminal 20 to represent the promise of fulfillment (step S114). Thereafter, in step S116, the process for requesting formatted print pages ends.

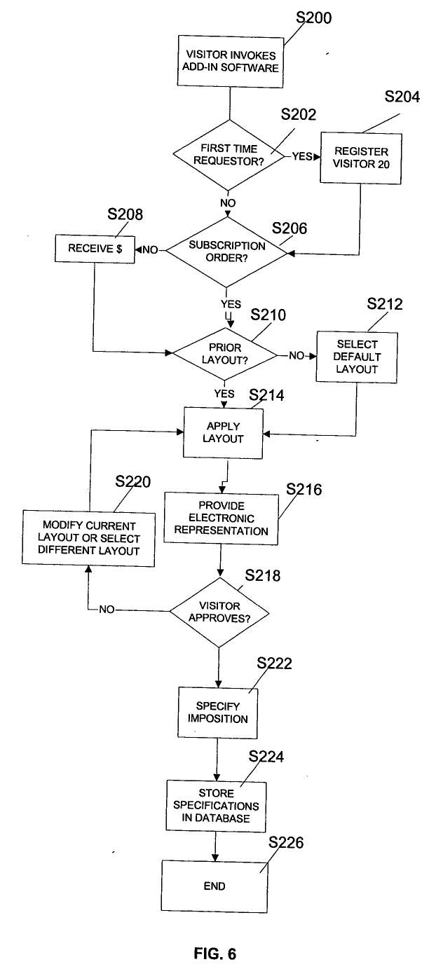

FIG. 6 shows a flow chart that identifies an example series of steps associated with processing a single transaction in accordance with the present invention. The flowchart shown in FIG. 6 is meant to illustrate one of several possible sequences of events, and is not intended to limit the present invention in any way.

In step S200, a visitor terminal 20 of customer web site 15 selects a control, for example, a button labeled “REQUEST” and provided by the add-in software to initiate a request for formatted print pages. A determination is preferably made whether the visitor terminal 20 has previously requested formatted print pages (step S202). If not, a registration process or other information gathering mechanism is invoked to “register” the user and establish terms in which formatted print pages are to be provided (step S204). For example, a visitor terminal 20 requests formatted print pages of content related to client web site 15 and enters into a subscription agreement with the proprietor of the production information processor 12 and/or the customer information processor 14 to receive formatted print pages in regular intervals, such as once weekly, monthly and the like. By offering subscriptions, visitor 20 payment can be made substantially automatically, and shipping and other information directed to visitor 20 can be retrieved easily. Preferably, payment is due prior to fulfilling a request for formatted print pages.

Continuing with the flow chart shown in FIG. 6, in step S206 the production information processor 12 determines whether the request 48 received from the customer information processor 14 is directed to a subscription or to an individual order. In the event that the request is directed to an individual order for formatted print pages, a payment process is completed prior to fulfilling the request (step S208).

After payment is received for an individual order, or the determination in step S206 indicates the request is part of a subscription, the process continues to step S210 and a determination is made whether to apply a previously used layout. If the production information processor 12 determines that no existing layout should be applied, then a “default” layout is preferably chosen from one or more layouts (step 212). Selecting which one of a plurality of default layouts is preferably based on control information received from the visitor terminal 20. Alternatively, the production information processor 12 analyzes the content to be included in formatted print pages in order to choose a layout. After the production information processor 12 selects a layout for the desired content, the layout is preferably applied (step S214).

Preferably, a database is used by the production information processor 12 to review, select and apply layouts, styles, and other related output directives. For example, front and back matter are preferably added to the formatted print pages. After a layout is applied, an electronic representation (i.e., a preview) of the formatted print pages is preferably provided for the visitor terminal 20 for review and approval (step S216). The electronic representation may be provided to the visitor terminal 20 while the visitor terminal 20 maintains an active session with the customer web site 15. Alternatively, the electronic representation may be e-mailed to the visitor terminal 20, or provided on the production web site 13. One skilled in the art will recognize that many other ways to provide previews of formatted print pages are known.

After the production information processor 12 provides the electronic representation of the formatted print pages, the visitor terminal 20 reviews the representation for approval. In step S218, the production information processor determines whether the visitor terminal 20 has approved the electronic representation. In the event that the visitor terminal 20 has not approved the electronic representation, the information processor 12 may modify the current layout, for example, by accepting selections and recommendations from the visitor terminal 20, or may select a different layout (step S220). Thereafter, the process loops back to step S214 and the revised or replaced layout is applied.

In the event that the production information processor 12 determines in step S218 that the visitor terminal 20 approves the electronic representation of the formatted print pages, then, in step S222, the production information processor preferably specifies the imposition of the formatted print pages, for example, including the serial order of pages, indices, and other content that is to be printed.

Thereafter, the production information processor 12 preferably stores specifications directed to the formatted print pages in a database for future access and use (step S224). At step S226, the process ends.

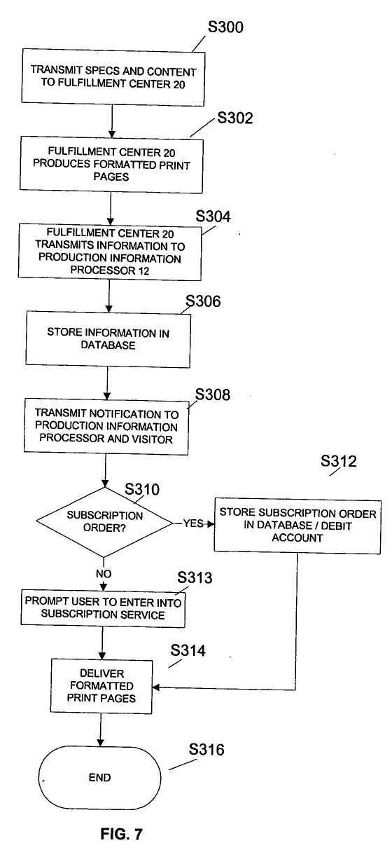

FIG. 7 is a flow chart identifying steps associated with fulfilling requests for formatted print pages after a request is received. In one embodiment, the flowchart shown in FIG. 7 effectively begins from step S224 shown in FIG. 6. In step S300, the production information processor 12 preferably transmits layout specifications and content to a fulfillment center terminal 22. Thereafter, a representative of the fulfillment center uses at least some of the hardware and software devices described above and shown in FIG. 2 to produce the formatted print pages (step S302). Included with layout specifications is information used by the operator of the fulfillment center terminal 22, for example, mailing information, shipping information and the like for fulfilling request 48.

The operator of the fulfillment center terminal 22, in step S304 preferably provides information that does not change in future requests for formatted print pages, such as a layout of individual pages, imposition for correct printing, identifying information and the like. Formatted print pages can be conveniently regenerated in future, similar requests, or when future issues of the same formatted print pages are requested. In step S306, the production information processor 12 preferably stores the information received from the fulfillment center terminal 20 in step S304 in a database.

At this point in the process, a request for formatted print pages has been received and processed, and the formatted print pages are ready to be delivered to the requesting visitor terminal 20. Accordingly, in step S308, a notification of the fulfillment of the request 48 is preferably transmitted by the production information processor 12 to the customer information processor 14 and/or to the visitor terminal 20. A determination is preferably made by the production information processor 12 whether the request 48 is part of a subscription agreement or not (step S310). If so, then, in step S312, subscription details directed to the order are preferably stored in a database. Moreover, the visitor's 20 prepaid account for the subscription is preferably debited in accordance with the costs associated with production and delivery of the formatted print pages. If the production information processor 12 determines, in step S310, the order is not part of a subscription, then an offer is preferably provided to the visitor terminal 20 to enter into a subscription agreement for future requests of formatted print pages (step S313).

The formatted print pages are then delivered in accordance with instructions received with the request for formatted print pages (step S314). At step S316, the process ends.

The above-identified system and method steps can be easily adapted for use with product catalogs displayed on web sites. The viewer can request the entire catalog, portions resulting from searching or selection criteria, or individual items. A web site may choose to offer such printed catalogs for free or for nominal cost.

The system can be used to order and produce a variety of materials, including: company and organization annual reports and other periodic or special statements; reprints of single articles in magazines; back issues of magazines no longer available from their original printing runs; and back issues of magazines unavailable in digital or computer form. For example, scanned images of one or more pages of a previously printed copy of a magazine is used by the production in formation processor 12 to provide formatted print pages. The present invention can be used for other materials, including brochures or booklets designed for insertion into plastic cases (commonly known as “jewel cases”) that are commonly used to store CDs, CDRs, DVDs, etc. The present invention is also applicable for other media storage devices, such as a booklet that is conveniently provided with an appropriately sized adhesive label to be added to a home-produced storage device. Moreover, customer web sites 15 can use the present invention to provide a finished looking product nearly identical to a fully produced retail product. Other printed materials that can be provided by the present invention include photographic and artistic image stock houses; portfolios of individual artists or photographers or groups of artists or photographers seeking professional work; portfolios of individual models or groups of models seeking professional work, for example, produced by the individual models, the groups of models, their agents, or companies representing them.

In another embodiment, the system is adapted to produce formatted print pages suitable for placement in loose-leaf or similar binders. In this case, formatted print pages are printed on computer printers that produce single-size rather than double-size pages, and layout software can be used to ensure that the margins are sufficiently wide to avoid the holes impinging on the formatted print pages. This is useful for content for formatted print pages that changes and is updated frequently, such as for technical manuals.

In order to facilitate rapid production of formatted print pages, different signatures can be provided by different printing devices, and eventually combined when the finished product of formatted print pages is perfect bound. Alternatively, the formatted print pages can be bound conventionally, rather than perfect bound. Further, the output of formatted print pages can be bound and produced as a hardcover book. The facilities described herein as production-related can also be dedicated to the production of formatted print pages for content identified in a single web site or group of web sites. Also, the customer web site 15 can order one or more copies of formatted print pages for its own purposes, including direct resale.

Optionally, all or some of the production of the formatted print pages can take place at a site open to the public, such as a commercial retail copying establishment. In such case, the customer can obtain the formatted print pages at the local retail outlet, rather than receiving the formatted print pages in the mail or other delivery method. Moreover, formatted print pages may comprise selections (“highlights”) from several formatted print pages of content from a single web site, or from several different web sites.

Additional functionality provided by system 10 is now further described by way of an example.

An Internet content provider that provides news and entertainment information on a web site desires to offer formatted print pages comprising the various on-line content. Accordingly, visitor terminal 20 (representing the content provider) visits a production web site 13. The information that is available to the operator of the visitor terminal 20 is informational in nature, and is suitable only for providing basic information directed to the services provided by the production information processor 12.

Accordingly, the operator of visitor terminal 20 makes a selection in the production web site 13 to make contact with the proprietor of the production web site 13. The proprietor of the production web site 13 receives the request for contact, and transmits an e-mail to the proprietor of the news and entertainment web site including a user name and password for accessing restricted portions of the production web site 13. Thereafter, the proprietor of the Internet news and entertainment web site uses the user name and password to access portions of the production web site 13 to review the many features provided thereby.

After reviewing the production web site 13 and engaging in further communications with the proprietor thereof, the proprietor of the news and entertainment Internet web site elects to enter into an agreement with the proprietor of the production web site 13 and to receive the add-in software and implement the many features described herein. Thereafter, the proprietor of the Internet news and entertainment web site installs the add-in software into the web site, and provides several notifications in the web site that formatted print pages of the web site is available to viewers. The proprietor of the news and entertainment Internet web site effectively becomes a proprietor of a customer web site 15.

Continuing with the present example, a visitor terminal 20 arrives at the Internet news and entertainment web site and desires to have several articles and corresponding photographs printed in a magazine-like format (i.e., as formatted print pages). Using the add-in software, the visitor terminal 20 clicks on appropriate portions of the customer web site 15 and identifies specific content that is desired for formatted print pages. The visitor terminal 20 is prompted to submit personal information, including name, shipping address, age and other demographic information. Further, the visitor terminal 20 is prompted to provide credit card or other information in order to pay for the order.

During the payment step, the visitor terminal 20 is preferably prompted to submit whether he would like a subscription to the on-line news and entertainment content to be regularly provided to him as formatted print pages. The visitor, knowing that he enjoys such content, thus submits that he would like a subscription to the content to be received monthly for one year. The add-in software preferably transmits the layout and other information directed to the formatted print pages, the on-line content and subscription to the production information processor 12, and receives back an estimate for the costs associated with fulfilling a request for formatted print pages. The estimate is preferably used to calculate a slightly higher fee by the customer information processor 14, and the final price is provided to the visitor terminal 20, for credit card or other payment information for the subscription.

After the visitor terminal 20 pays for the subscription, the production information processor 12 receives request 48 that includes a pointer to the content and the control information. After determining that the payment processing is complete, the production information processor 12 determines that this is a first order for this visitor terminal 20, and proceeds to retrieve the content from the customer web site 15. Moreover, the production information processor 12 applies layout and style as directed by the control information.

Additional information, such as front and back matter, including table of contents, index and appendix are also added to the layout for the formatted print pages by the production information processor 12. Thereafter, the production information processor 12 transmits an electronic representation of the formatted print pages to the customer information processor 14. The customer information processor 14 preferably provides the electronic representation of the formatted print pages to the visitor terminal 20 via the customer web site 15, or some other way (described above).

After reviewing the electronic representation, the visitor terminal 20 provides his approval, for example, by clicking a button that says “I approve.” Thereafter, the production information processor 12 preferably specifies the imposition, including the serial order of pages and other portions in the formatted print pages. The specifications directed to the formatted print pages are preferably stored in a database for future use.

The production information processor 12 transmits the specifications directed to the formatted print pages to a fulfillment facility terminal 22 where the specifications are received and printing processes commence. In addition to printing the content, and front and back matter, the output is printed to the edge of the printed page, such that “full-bleed” printing is achieved without the need for trimming. Additionally, during the output process, one of a plurality of printers supplied with pages of different quality, size and thickness are used for printing the different parts of the formatted print pages, such as the cover. Additionally, a paper folder is used to prepare each sheet for binding, and one or more machines is used to “saddle stitch” the pages along the centerfold.

After production of the formatted print pages is complete, a notification is transmitted from the fulfillment facility terminal 22 to the customer information processor 14. The customer information processor 14 transmits an email or other notification to the visitor terminal 20 that the formatted print pages have been prepared, and are being shipped. Since the visitor terminal 20 indicated that he would like a subscription to this content, the production information processor 12 preferably stores information in a database for reproducing the formatted print pages, with updated content provided on the customer web site 15. Thereafter, the visitor terminal 20 receives the formatted print pages.

In one embodiment, the customer web 15 site electronically provides electronic information regarding an order for formatted print pages comprising content provided thereon via the production information processor 12. For example, the visitor terminal 22 is redirected to the production information processor 12 for processing an order for formatted print pages. The electronic information can be transmitted from the production information processor 12 to the fulfillment facility terminal 22.

In an alternative embodiment, the customer information processor 13 provides much of the functionality described independently of the production information processor 12. For example, the customer information processor 13 provides at least partial electronic information regarding formatted print pages that comprise at least content on the customer web site 15. For example, the customer information processor 15 uses known software tools (e.g., QUARK and ADOBE PAGEMAKER) to contribute to the definition of formatted print pages. Alternatively, the production information processor 12 provides software tools for providing information regarding formatted print pages. The information can be transmitted from the customer information processor to the fulfillment facility terminal 22 (or, indirectly via the production information processor 12) for use in production of formatted print pages.

Furthermore, the electronic version of the invariant portion of the order for formatted print pages can be stored either by the customer information processor 14 or by the production information processor 12. If electronic information regarding an order for formatted print pages is transmitted directly from the customer web site 15 to the fulfillment facility terminal 22, some information regarding the order is transmitted to the production information processor 12, for example, from the customer web site 15 or from the fulfillment facility terminal 22. In this way, the production information processor 12 is provided a record of the order for formatted print pages, for example for accounting purposes.

Thus, the present invention provides a new way to provide formatted print pages comprising content from one or more Internet web sites. Although the invention has been described in terms of providing monographs, serial publications and magazines, the invention is not so limited. For example, the fulfillment facility terminal 22 can provide various sized posters of Internet web site content that are significantly larger than can be produced, for example, on a home computer printer. Moreover, a standard poster-sized layout template can be used to produce the poster, Use of a template can facilitate providing additional information in the poster, such as a photographer, artist, copyright notice, etc. Since home computer printers are unable to print posters (e.g., full-bleed images on oversized paper) the present invention provides a new way to receive custom posters. Further, the typical home computer system is not equipped with a printer with a roll-fed supply of paper, so pages of great size or variable length are difficult, if not impossible, to produce thereby.

Also, some posters are provide with inspirational or other text, such as poetry. Such text can also be provided with a poster. For example, system 10 allows visitors to provide combinations of image(s) and text (including text provided by the visitor 20) and a poster comprising the image(s) and text are combined in the finished poster. Preferably, the fulfillment facility terminal 22 has access to containers suitable for mailing or shipping posters without damaging or folding the posters.

Another form of output provided by the present invention is a calendar, for example a wall or desk calendar. More particularly, the present invention can produce calendars that are too big to print on the typical home computer printer. Preferably, the wall and/or desk calendars are mounted on cardboard or other stiffening backing, have clear protective covers, punched for hanging (wall calendar) or have an easel stand for standing or be spiral bound (desk calendar). In accordance with the present invention, the calendar does not exist until the visitor terminal 20, using the features of system 10 described above, selects images to be included on one or more pages of the calendar, and the image(s) are properly sized to fit. The visitor terminal 20 may receive prompts that suggest one or more images for a calendar, or the visitor terminal 20 may select images from one or more web sites.

Other uses and products provided by the present invention will be apparent to those skilled in the art.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for providing printed pages of web hosted information in response to an electronic request received over a communication network, the method comprising:
providing add-in software operable with a web site, the add-in software enabling a visitor of the web site to submit a request for receiving a printed copy of web hosted information that is displayable as web pages;
receiving electronic order information representing the request;
processing the electronic order information to provide electronic production information representing instructions for fulfilling the request;
transmitting the electronic production information to a fulfillment facility; and
providing to the visitor the requested web hosted information from the fulfillment facility in the form of printed pages.

2. The method of claim 1, wherein the electronic order information is prepared by the add-in software.

3. The method of claim 1, further comprising providing an estimate for costs associated with providing the printed pages.

4. The method of claim 3, wherein the estimate is partly based on a requested style for the printed pages.

5. The method of claim 4, wherein the style includes at least one of binding, saddle-stitching, paper size, two-sided printing and full-bleed printing.

6. The method of claim 4, wherein the add-in software enables the visitor to select a predefined layout and to modify the predefined layout.

7. The method of claim 1, wherein the printed pages are provided by printing on oversized paper and trimming the oversized paper to appear as produced by full-bleed printing.

8. The method of claim 1, wherein the step of preparing the electronic order information comprises selecting a style for the printed pages, the style including at least one of page layout, inside and outside of a front cover, inside and outside of a back cover, double-sided printing, and single-sided printing.

9. The method of claim 8, wherein the step of choosing the style includes making a selection from a plurality of thumbnail images, each of the plurality of thumbnail images representing a style.

10. The method of claim 9, wherein the visitor provides a request a modification to the style.

11. The method of claim 10, wherein the request is provided by email.

12. The method of claim 8, wherein the step of choosing the style includes at least one of generating a new style and modifying an existing style.

13. The method of claim 1, wherein the print pages are packaged with at least one other item.

14. The method of claim 13, wherein the at least one other item includes advertising material.

15. The method of claim 1, wherein the step of processing the electronic order information comprises providing at least one of front information, back information and spine information.

16. The method of claim 15, wherein the front information comprises at least one of a table of contents, forward and advertising.

17. The method of claim 15, wherein the back information comprises at least one of an index, an appendix, a table and a glossary.

18. The method of claim 1, wherein the add-in software further enables a user to provide at least one of related personal and professional information.

19. The method of claim 1, wherein the add-in software further provides customer web site information, the customer web site information regarding at least one of the uniform resource locator of the web site, the IP address of the web site and the name of the proprietor of the web site.

20. The method of claim 1, further comprising providing a production web site, the production web site providing prospective customers information regarding providing the printed pages.

21. The method of claim 20, wherein the production web site further provides restricted access to registered users.

22. The method of claim 21, wherein the restricted access enables registered users to receive electronic information regarding orders for printed materials.

23. The method of claim 1, wherein the fulfillment facility provides the printed pages such that they have been subject to at least one of folding, binding and saddle stitching.

24. The method of claim 1, further comprising at least one of transmitting an invoice for the printed pages and receiving electronic payments for providing the printed pages.

25. The method of claim 1, wherein the printed pages further comprise ownership information.

26. The method of claim 25, wherein the ownership information includes copyright information and production information, the production information including information regarding the fulfillment facility.

27. The method of claim 1, further comprising storing a style in a database corresponding to respective visitors, and selecting a stored style for respective visitors in future production of printed pages.

28. A remotely controlled method for the production of bound books responsive to individual book orders, the method comprising:
providing access via an Internet connection to a plurality of remote potential book buyers in the form of web pages that display at least a portion of the contents of books for perusal and review;
operating a facility that enables the potential remote book buyer to place an order or orders for one or more selected books;
processing orders for books whose contents are represented by web pages;
communicating the order, including selection and the ordered book's content to a fulfillment facility;
executing at the fulfillment facility a series of steps that convert the communications into a bound book; and
delivering the book to the book buyer.

29. A system for providing formatted print pages that comprise content represented in a web site, the system comprising:
add-in software operable with the web site, the add-in software enabling a visitor of the web site to submit an electronic request for the formatted print pages;
a request receiving module that receives the electronic request over a communication network;
a request processing module that processes the contents of the electronic request and provides electronic production information that provides instructions for fulfilling the electronic request;
a transmitting module that transmits the electronic production information to a fulfillment facility operable to provide the formatted print pages corresponding with the electronic production information; and
a formatted print pages delivery module operable to provide to the visitor the formatted print pages.

30. The system of claim 29, further comprising a production information processor providing the add-in software, the production information processor further providing a production web site, the production web site comprising at least public content for registered and non-registered visitors, and private content for registered visitors.

31. The system of claim 30, wherein the public content comprises information regarding at least one of the add-in software, the request receiving module, the request processing module, the transmitting module and the formatted print pages delivery module.

32. The system of claim 30, wherein the private content comprises at least one of content received from the web site and content not received from the web site, wherein the content is to be included in the formatted print pages.

33. The system of claim 30, further comprising a search module, the search module providing a location of content related to content provided in the web site.

34. The system of claim 33, wherein content located by the search module is included in the formatted print pages.

35. The system of claim 30, further comprising at least one of a laser printer, a bubble jet printer, an ink jet printer, a dye emulsion printer, and a full-bleed printer.

36. The system of claim 30, wherein the electronic request includes electronic content information representing the content for the formatted print pages, and control information representing at least a style of the formatted print pages.

37. The system of claim 36, wherein the control information further comprises at least one of an identification of the web site, the portion of the web site for the formatted print pages, and the version of the formatted print pages.

38. The system of claim 36, wherein the control information further comprises at least one of the name, mailing address, shipping specifications and e-mail address of the party submitting the electronic request.

39. The system of claim 36, wherein the style of the formatted print pages includes at least one of the front matter, the back matter, and components that are repeated in the formatted print pages.

40. The system of claim 29, wherein the communication network is the Internet.

41. The system of claim 29, further comprising a formatted print pages style module that provides a selection of at least one formatted print pages style template.

42. The system of claim 41, wherein the at least one formatted print pages style template is used to produce formatted print pages that comply with a formatted print pages style.

43. The system of claim 41, wherein the formatted print pages style module provides tools for manipulating a selected formatted print pages style template.

44. The system of claim 29, further comprising a simulation module that provides an electronic simulated representation of the formatted print pages.

45. The system of claim 44, further comprising an approval module that prompts the viewer for approval after the simulation module provides the electronic simulated representation of the formatted print pages.

46. The system of claim 44, wherein the electronic simulation is at least a partial representation of the formatted print pages.

47. The system of claim 44, wherein the electronic request comprises the electronic simulated representation.

48. The system of claim 29, further comprising a subscription module that prompts the visitor to enter into a subscription agreement for receiving future formatted print pages.

49. The system of claim 46, wherein a single payment for a plurality of orders for formatted print pages is provided by the visitor.

50. The system of claim 29, further comprising an e-commerce module performs at least one of generating a cost for receiving formatted print pages and accepting payment for formatted print pages.

51. The system of claim 29, wherein the formatted print pages include at least one of a company annual report, a wall calendar, a desk calendar and a poster.

52. The system of claim 29, wherein the content comprises an article in a previously printed magazine.
